(19) United States
(12) Patent Application Publication
(10) Pub. No.: US 2025/0383793 A1
(43) Pub. Date: Dec. 18, 2025

(54) APPARATUSES AND METHODS FOR AUTO POWER-DOWN IN SEMICONDUCTOR MEMORY DEVICES

(71) Applicant: Micron Technology, Inc., Boise, ID (US)

(72) Inventors: Yang Lu, Boise, ID (US); Kang-Yong Kim, Boise, ID (US); Hyun Yoo Lee, Boise, ID (US)

(73) Assignee: Micron Technology, Inc., Boise, ID (US)

(21) Appl. No.: 19/240,311

(22) Filed: Jun. 17, 2025

Related U.S. Application Data
(60) Provisional application No. 63/660,994, filed on Jun. 17, 2024.
(60) Provisional application No. 63/667,053, filed on Jul. 2, 2024.

(51) Int. Cl. G06F 3/06

(52) U.S. Cl. CPC G06F 3/0625; G06F 3/0634; G06F 3/0673

(57) ABSTRACT

Apparatuses and methods for auto power-down in semiconductor memory devices are described. An example method for entering power-down for a memory device includes receiving at the memory device a command to perform a memory operation. When auto power-down for the command is not enabled by a mode register setting, performing the memory operation in response to the command. When auto power-down for the command is enabled by the mode register setting, performing the memory operation in response to the command, and entering power-down in response to the command.

### CROSS-REFERENCE TO RELATED APPLICATIONS

This application claims the filing benefit of U.S. Provisional Application No. 63/660,994, filed Jun. 17, 2024, and U.S. Provisional Application No. 63/667,053, filed Jul. 2, 2024. These applications are incorporated by reference herein in their entirety and for all purposes.

### BACKGROUND

A semiconductor memory device may include a number of memory cells which are used to store data represented by binary digits (or “bits”). The memory cells are typically arranged in an array and the memory cells are accessed based on row addresses and column addresses.

In an effort to conserve power, memory devices may have a power-down mode that can reduce power consumption of the memory devices, for example, when the memory devices are not accessed. Power may be conserved during the power-down state by powering down one or more internal memory circuits that are not necessary to preserve stored data. For example, a semiconductor memory device may include a number of signal input buffers that are used to receive input signals (e.g., command and address (CA) input buffers that receive signals for commands and addresses). The signal input buffers consume power even when active signals are not received by the signal input buffers.

During a power-down state, one or more of the signal input buffers may be powered down or remain in a mode having reduced power consumption in order to reduce the power consumption of the semiconductor memory device. The signal input buffers are activated when the memory device exits the power-down mode, for example, when the memory device is to be accessed.

### BRIEF DESCRIPTION OF THE DRAWINGS

FIG. 1 is a block diagram of an example system according to an embodiment of the disclosure.

FIG. 2 is a block diagram of an example semiconductor device according to an embodiment of the disclosure.

FIG. 3 is a block diagram of an example memory module according to an embodiment of the disclosure.

FIG. 4 is a block diagram of example power-down circuitry according to an embodiment of the disclosure.

FIG. 5 is a block diagram of example command address circuitry according to an embodiment of the disclosure.

FIG. 6 is a table showing a mode register definition for an auto power-down feature according to an embodiment of the disclosure.

FIG. 7 is a diagram showing the timing of an auto power-down entry according to an embodiment of the disclosure.

FIG. 8 is a diagram showing the timing of an auto power-down entry according to an embodiment of the disclosure.

FIG. 9 is a diagram showing the timing of an auto power-down entry according to an embodiment of the disclosure.

FIG. 10 is a diagram showing the timing of an auto power-down entry according to an embodiment of the disclosure.

FIG. 11 is a diagram showing the timing of an auto power-down entry according to an embodiment of the disclosure.

FIG. 12 is a diagram showing the timing of an auto power-down entry according to an embodiment of the disclosure.

### DETAILED DESCRIPTION

Embodiments described herein provide systems and methods for auto power-down in semiconductor memory devices. For example, a power-down mode may be entered automatically for a specific command that is not an explicit power-down mode entry command and/or a power-down mode may be entered automatically for a sequence of commands for an operation other than power-down mode entry. A separate explicit power-down entry command is unnecessary to enter power-down mode for the specific command associated with auto power-down. The specific command(s) after which the power-down mode is automatically entered may be user configured, such as by setting memory device auto power-down configurations using a mode register.

An example command for auto power-down is a refresh command REF. A refresh command causes the memory to refresh memory cells of a memory array. When the auto power-down mode is set for the REF command, a refresh operation is performed and the power-down mode will be entered for the REF command, without the need for a separate explicit power-down entry command. Another example command for auto power-down is an activate command ACT. An activate command causes the memory to activate memory cells of a memory array. When the auto power-down mode is set for the ACT command, an activate operation is performed and the power-down mode will be entered for the ACT command, without the need for a separate explicit power-down mode entry command. Another example command for auto power-down is a precharge command PRE. A precharge command causes the memory to precharge memory array circuits (e.g., bit lines, sense amplifiers, data and write amplifiers, input/output lines of a data path, etc.) in preparation for another access operation to the memory array. When the auto power-down mode is set for the PRE command, a precharge operation is performed and the power-down mode will be entered for the PRE command, without the need for a separate explicit power-down mode entry command. Other commands may be used as well to trigger auto power-down. That is, more generally, when the auto power-down mode is set for a command, a corresponding operation is performed and the power-down mode will be entered for the command, without the need for a separate explicit power-down mode entry command.

An example of a sequence of commands is when the power-down mode is entered in response to the memory receiving a number of received commands. For example, the power-down mode will be entered in response to the memory receiving deselect commands DES. A deselect command deselects the memory device and causes the memory device to be in an idle state. In some embodiments, the commands need to be consecutive to trigger the power-down mode. In some embodiments, power-down mode is triggered when the number of commands are received, even if not consecutive. In some embodiments, power-down will be entered when N+16 consecutive DES commands are received. N may be specified by an APD hold-off operand in a mode register for auto power-down configuration in some embodiments of the disclosure. 16 commands in excess of N is provided as a non-limiting example. In some embodiments, the number of commands in excess of N may be greater or less than 16 commands.

Embodiments of the disclosure may be broadly applicable to various types of DRAM. For example, embodiments of the disclosure may include semiconductor memory, such as DDR5, DDR6, and future iterations of DDR memory. Additionally, embodiments of the disclosure may include low power double data rate (LPDDR) DRAM, such as LPDDR5, LPDDR6, and future iterations of LPDDR memory. More generally, embodiments of the disclosure include, or may be included in, semiconductor memory, including various types of nonvolatile memories and other volatile memories. Embodiments of the disclosure also include memory systems, such as memory modules and embedded memory systems which may include one or more memory devices that include auto power-down features as disclosed.

An Auto Power-Down (APD) feature may help a system use a power-down mode more often without command address (CA) bandwidth concern, and consequently, save more power.

In some embodiments, an APD feature can be enabled by using a mode register (MR). When APD is enabled, a memory will enter a power-down mode automatically for a specific command (the specific command is different than an explicit power-down mode entry command), or in some embodiments, after receiving a sequence of commands (e.g., a number of deselect commands (DES) received). MR bits can be set to configure which command(s) will trigger power-down entry automatically, and set a hold-off value for when power-down entry is triggered.

As previously discussed, during a power-down mode, power consumption by the memory device may be reduced, thereby conserving power. For example, during power-down, one or more signal input buffers, such as CA input buffers, are deactivated to save power. Some signal input buffers may remain enabled, such as signal input buffers for a chip select (CS) signal and/or signal input buffers for one or more clocks (e.g., CK), and/or reset. Another example is deactivating or reducing power consumption by one or more voltage generator circuits during a power-down state.

In some embodiments of the disclosure, APD may not be triggered if the memory device is already in power-down mode (or a power-down entry).

A power-down exit command can cause the memory device to exit power-down regardless of how a power-down mode was entered. For example, a power-down exit command can cause the memory device to exit power-down mode whether the power-down mode was entered using an explicit power-down entry command or entered using auto power-down according to an embodiment of the disclosure.

As previously described, a mode register may be used for configuring auto power-down in some embodiments of the disclosure.

In some embodiments of the disclosure, an APD Enable setting is not included, and APD may be configured and enabled using other MR settings for the auto power-down configuration, for example, enabling specific commands to trigger power-down entry.

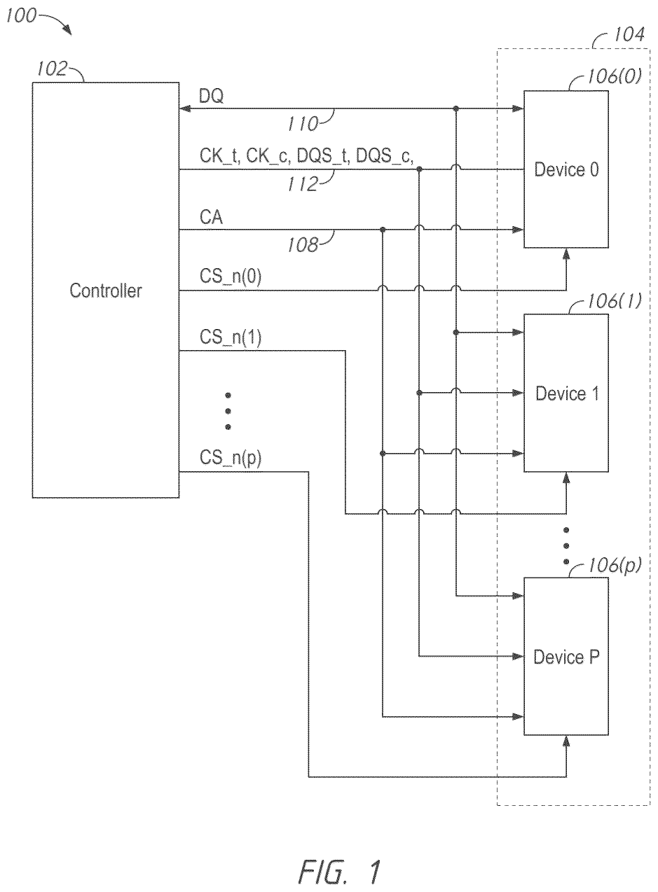

FIG. 1 illustrates a block diagram of an example system 100 according to an embodiment of the disclosure. The system 100 includes a controller 102 and a memory system 104. In the illustrated embodiment, the memory system 104 includes memory devices 106(0)-106(p) (e.g., “Device 0” through “Device p”), where p is a number greater than one (1).

In one embodiment, the memory system 104 is a memory module and the memory devices 106(0)-106(p) are memory ranks. The memory devices 106(0)-106(p) may include a dynamic random access memory (DRAM), a double data rate (DDR) memory, a low power double data rate (LPDDR) memory, a graphics double data rate (GDDR) memory, or other type of memory. Each memory rank can include one or more memory devices (e.g., DRAM devices).

The memory devices 106(0)-106(p) are each coupled to the command/address, data, and clock busses. The controller 102 and the memory system 104 are in communication over several busses. Commands and addresses (CA) are received by the memory system 104 on a command/address bus 108, and data (DQ) is provided between the controller 102 and the memory system 104 over a data bus 110. Various clocks may be provided between the controller 102 and the memory system 104 over a clock bus 112. The clock bus 112 may include signal lines for providing system clocks CK_t and CK_c received by the memory system 104 and data clocks (strobes) DQS_t and DQS_c received by the memory system 104 and/or provided to the controller 102. Each of the busses may include one or more signal lines on which signals are provided.

The CK_t and CK_c clocks provided by the controller 102 to the memory system 104 are used for timing the provision and receipt of the commands and addresses. The DQS_t and DQS_c clocks are used for timing provision of data. The CK_t and CK_c clocks are complementary, and the DQS_t and DQS_c clocks are complementary. Clocks are complementary when a rising edge of a first clock occurs at a same time as a falling edge of a second clock, and when a rising edge of the second clock occurs at a same time as a falling edge of the first clock.

The controller 102 provides commands to the memory system 104 to perform memory operations. Examples of memory commands include timing commands for controlling the timing of various operations, explicit power-down entry and exit commands and commands for auto power-down for controlling entry into power-down, access commands for accessing the memory, such as read commands for performing read operations and write commands for performing write operations, activation commands, refresh command, activate command, precharge command, deselect command, no operation commands, as well as other commands. The command signals provided by the controller 102 to the memory system 104 further include external control signals (e.g., chip select signals CS_n (0), CS_n (1), CS_n (p)).

The memory devices 106(0)-106(p) are provided the commands, addresses, data, and clocks, and the external control signals provided on respective select signal lines are used to select which of the memory devices 106(0)-106(p) (or memory ranks) will respond to the command and perform the corresponding operation. In some embodiments, a respective control signal is provided to each memory device 106(0)-106(p) of the memory system 104. In some embodiments, the memory devices included in a rank are provided a same control signal. The controller 102 provides an active control signal to select the corresponding memory device 106(0)-106(p). While the respective control signal is active, the corresponding memory device 106(0)-106(p) is selected to receive the commands and addresses provided on the command/address bus 108. In some embodiments, the external control signal is used in combination with the CA signals to indicate different memory commands and memory operations.

In operation, when a read command and associated address are provided by the controller 102 to the memory system 104, the memory device 106(0)-106(p) selected by the external control signals receives the read command and associated address, and performs a read operation to provide the controller 102 with read data from a memory location corresponding to the associated address. The read data is provided by the selected memory device 106(0)-106(p) to the controller 102 according to a timing relative to receipt of the read command. For example, the timing may be based on a read latency (RL) value that indicates the number of clock cycles of the CK_t and CK_c clocks (a clock cycle of the CK_t and CK_c clocks is referenced as tCK) after the read command when the read data is provided by the selected memory device 106(0)-106(p) to the controller 102.

The RL value is programmed by the controller 102 in the memory devices 106(0)-106(p). For example, the RL value may be programmed in respective mode registers of the memory devices 106(0)-106(p). As known, mode registers included in each of the memory devices 106(0)-106(p) may be programmed with information for setting various operating modes and/or to select features for operation of the memory devices 106(0)-106(p). One of the settings may be for the RL value. In some embodiments of the disclosure, mode register settings may include power-down mode configurations, such as related to an auto power-down feature according to some embodiments of the disclosure.

In preparation of the selected memory device 106(0)-106(p) providing the read data to the controller 102, the memory device provides active data clocks DQS_t and DQS_c. A clock is active when the clock transitions between low and high clock levels periodically. Conversely, a clock is inactive when the clock maintains a constant clock level and does not transition periodically. The DQS_t and DQS_c clocks are provided by the memory device 106(0)-106(p) performing the read operation to the controller 102 for timing the provision of read data to the controller 102. The controller 102 may use the DQS_t and DQS_c clocks for receiving the read data.

In operation, when a write command and associated address are provided by the controller 102 to the memory system 104, the memory device 106(0)-106(p) selected by the external control signals receives the write command and associated address, and performs a write operation to write data from the controller 102 to a memory location corresponding to the associated address. The write data is provided to the selected memory device 106(0)-106(p) by the controller 102 according to a timing relative to receipt of the write command. For example, the timing may be based on a write latency (WL) value that indicates the number of clock cycles of the CK_t and CK_c clocks after the write command when the write data is provided to the selected memory device 106(0)-106(p) by the controller 102. The WL value is programmed by the controller 102 in the memory devices 106(0)-106(p). For example, the WL value may be programmed in respective mode registers of the memory devices 106(0)-106(p).

In preparation of the selected memory device 106(0)-106(p) receiving the write data from the controller 102, the controller 102 provides active data clocks DQS_t and DQS_c to the memory system 104. The DQS_t and DQS_c clocks may be used by the selected memory device 106(0)-106(p) to generate internal clocks for timing the operation of circuits to receive the write data. The data is provided by the controller 102 and the selected memory device 106(0)-106(p) receives the write data according to the DQS_t and DQS_c clocks, which is written to a memory location corresponding to the memory address.

One or more of the memory devices 106(0)-106(p) may include a power-down controller and/or an auto power-down feature according to an embodiment of the disclosure. For example, in some embodiments of the disclosure, a power-down controller controls entry into a power-down state for specific commands that are not an explicit power-down entry command, and/or the power-down controller controls entry into a power-down state for a sequence of commands other than an explicit power-down entry command. Examples of power-down controllers and auto power-down operations may be included in one or more of the memory devices 106(0)-106(p) in some embodiments of the disclosure. The specific commands causing entry of the power-down mode may be user enabled, such as by setting memory device auto power-down configurations using the mode register.

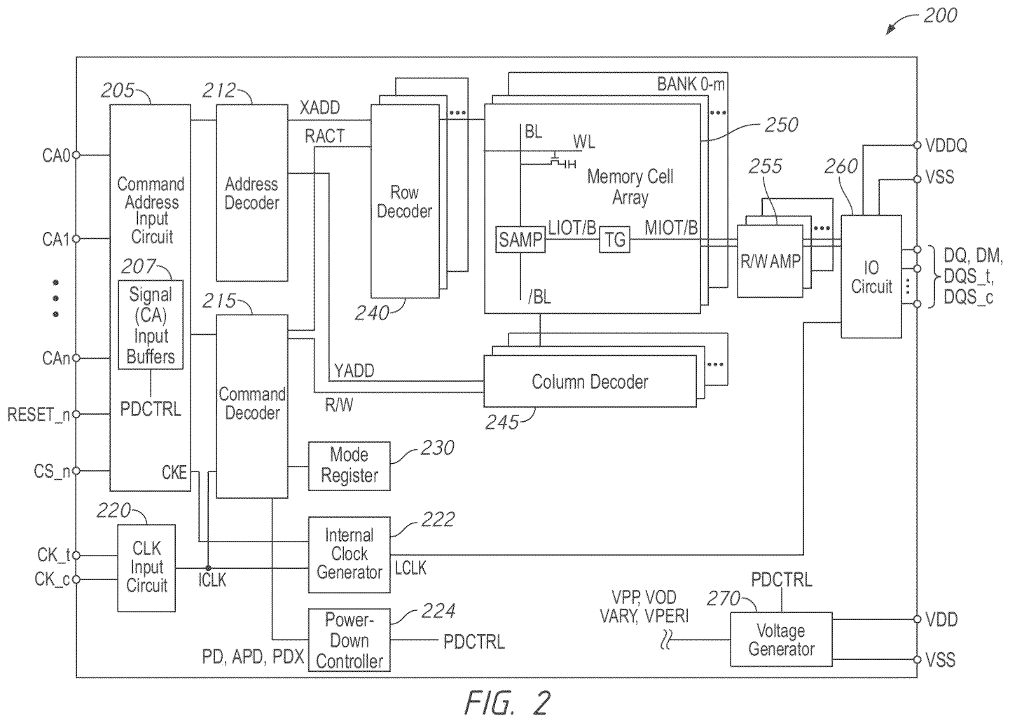

Mode register write commands and mode register read commands can be used to access the mode registers (e.g., mode register 230 in FIG. 2). In operation, when a mode register read command and associated address are provided by the controller 102 to the memory system 104, the memory device selected by the select signals receives the mode register read command and associated address, and performs a mode register read operation to provide the controller 102 with information from the mode register corresponding to the associated address. The information is provided by the selected mode register to the controller 102. When a mode register write command and associated address are provided by the controller 102 to the memory system 104, the memory device selected by the select signals receives the mode register write command and associated address, and performs a mode register write operation to write information provided by the controller 102 to a mode register corresponding to the associated address. The information is provided to the selected mode register by the controller 102.

FIG. 2 illustrates a block diagram of a semiconductor device according to an embodiment of the disclosure. The semiconductor device 200 may include, without limitation, a memory such as a DRAM. In one embodiment, one or more semiconductor devices 200 are included in a memory rank. In some embodiments, the semiconductor device 200 may be included in one or more of the memory devices 106(0)-106(p) of the memory system 104 of FIG. 1.

The semiconductor device 200 includes a memory array 250. The memory array 250 is shown as including a plurality of memory banks. In the embodiment of FIG. 2, the memory array 250 is shown as including memory banks BANK0-BANKm. Each memory bank includes a plurality of word lines WL, a plurality of bit lines BL and/BL, and a plurality of memory cells MC arranged at intersections of the plurality of word lines WL and the plurality of bit lines BL and/BL. Selection of the word line WL is performed by a row decoder 240 and selection of the bit lines BL and/BL is performed by a column decoder 245. In the embodiment of FIG. 2, the row decoder 240 includes a respective row decoder for each memory bank and the column decoder 245 includes a respective column decoder for each memory bank. The bit lines BL and/BL are coupled to a respective sense amplifier (SAMP). Read data from the bit line BL or/BL is amplified by the sense amplifier SAMP and transferred to read/write amplifiers 255 over complementary local data lines (LIOT/B), transfer gate (TG), and complementary main data lines (MIOT/B). Conversely, write data output from the read/write amplifiers 255 is transferred to the sense amplifier SAMP over the complementary main data lines MIOT/B, the transfer gate TG, and the complementary local data lines LIOT/B, and written in the memory cell MC coupled to the bit line BL or/BL. One or more of the previously described circuits may be considered as a memory array circuit that is associated with the memory array 250. The memory array circuits may be used for memory array operations, for example, for a read operation, write operation, refresh operation, activate operation, precharge operation, and/or accessing the memory array 250.

A mode register 230 stores information, for example, configuration and status information for the semiconductor device 200. In some embodiments, the mode register 230 stores information for configuring auto power-down settings, for example, as described in greater detail below. The mode register may be accessed through mode register read commands and mode register write commands. The mode register access commands cause the semiconductor device 200 to perform mode register read operations and mode register write operations. A mode register read command causes the semiconductor device 200 to provide information stored by the mode register that is accessed, and a mode register write command causes the semiconductor device 200 to store information in the mode register that is accessed. The mode register 230 may include several mode registers, with each of the mode registers corresponding to a mode register address and storing different types of information.

The semiconductor device 200 may employ a plurality of external terminals that include command and address (CA) and control terminals (Reset_n and CS_n) coupled to a command and address bus to receive commands and addresses, an external reset_n signal and an external control CS_n signal. The external terminals may further include clock terminals to receive clocks CK_t and CK_c, and data clocks DQS_t and DQS_c, data terminals DQ and DM, and power supply terminals to receive power supply potentials VDD, VSS, and VDDQ.

The clock terminals are supplied with external clocks CK_t and CK_c that are provided to a CLK input buffer 220. The external clocks may be complementary. The CLK input buffer 220 generates an internal clock ICLK based on the CK_t and CK_c clocks. The ICLK clock is provided to the command decoder 215 and to an internal clock generator 222. The internal clock generator 222 provides various internal clocks LCLK based on the ICLK clock. The LCLK clocks may be used for timing operation of various internal circuits.

The CA terminals (e.g., CAO-CAn) may be supplied with commands and memory addresses. The command/address input circuit 205 includes CA input buffers 207 that receive command and address signals for the commands and memory addresses. The memory addresses supplied to the CA terminals are transferred, via a command/address input circuit 205, to an address decoder 212. The address decoder 212 receives the address and supplies a decoded row address XADD to the row decoder 240 and supplies a decoded column address YADD to the column decoder 245.

The CA terminals may be supplied with commands. Examples of commands include access commands for accessing the memory, such as read commands for performing read operations and write commands for performing write operations, mode register write and read commands for performing mode register write and read operations, explicit power-down mode entry and exit commands and commands for auto power-down for controlling entry into and exit from a power-down mode, activation commands, power down exit commands, refresh command, activate command, precharge command, deselect command, no operation command, as well as other commands and operations. The commands may be provided as internal input command signals to a command decoder 215 via the command/address input circuit 205. The command decoder 215 includes circuits to decode the internal input command signals to generate various internal signals and commands for performing operations. For example, the command decoder 215 may provide a row command signal RACT to select a word line and a column command signal R/W to select a bit line.

The command decoder 215 also provides internal power-down command signals to a power-down controller 224. For example, the command decoder 215 provides internal power-down entry command signal PD and auto power-down signal APD to the power-down controller 224. The command decoder 215 may provide an active internal power-down entry command signal PD when an explicit power-down entry command is received by the command/address input circuit 205. An active internal auto power-down signal APD may be provided to the power-down controller 224 when auto power-down is enabled for one or more specific commands and the one or more specific commands is received by the command/address input circuit 205. In some embodiments, the PD and APD signals are the same signal, with an active PD/APD signal causing entry into power-down for an explicit power-down entry command received by the command/address input circuit 205 and/or for auto power-down when auto power-down is enabled for one or more specific commands and the one or more specific commands is received by the command/address input circuit 205. Another example of an internal command signal provided by the command decoder 215 to the power-down controller 224 is an internal power-down exit command signal PDX. An active PDX signal may be provided by the command decoder 215 to the power-down controller 224 when a power-down exit command is received by the command/address input circuit 205.

Based on the internal power-down command signals, for example, the PD/APD and PDX internal command signals, the power-down controller 224 provides internal power-down control signal(s) PDCTRL to activate and deactivate memory circuits for a power-down state. When power-down is triggered, the PDCTRL signal is provided (e.g., having a first logic level) to cause memory circuits to reduce power consumption and/or be deactivated for an explicit power-down entry command, and in response to one or more specific commands when auto power-down is enabled for the one or more specific commands. An example memory circuit that may be deactivated or placed into a reduced power consumption mode for power-down mode is a signal input buffer. CA input buffers 207 included in the command/address input circuit 205 are examples of signal input buffers that may be deactivated for a power-down state. Another example memory circuit that may be deactivated or placed into a reduced power consumption mode for power-down mode is an internal voltage generator circuit. Internal voltage generator circuit 270 is an example of voltage generator circuit that may be deactivated for a power-down state. Other example memory circuits include clock circuits, including delay-lock loops, frequency dividers, phase splitters, etc., amplifier circuits, and memory circuits related to decoding addresses and accessing the memory array. When power-down is exited, the power-down controller 224 provides the PDCTRL signal (e.g., having a second logic level) to activate the deactivated memory circuits, for example, when an active PDX internal command signal is provided by the command decoder 215.

The power supply terminals are supplied with power supply potentials VDD and VSS. The power supply potentials VDD and VSS are supplied to an internal voltage generator circuit 270. The internal voltage generator circuit 270 generates various internal potentials VPP, VOD, VARY, VPERI, and the like based on the power supply potentials VDD and VSS supplied to the power supply terminals. The internal potential VPP is mainly used in the row decoder 240, the internal potentials VOD and VARY are mainly used in the sense amplifiers SAMP included in the memory array 250, and the internal potential VPERI is used in many peripheral circuit blocks. As previously described, the internal voltage generator circuit 270 may be deactivated or controlled to have reduced power consumption during a power-down state.

The power supply terminals are also supplied with power supply potentials VDDQ and VSS. The power supply potentials VDDQ and VSS are supplied to the input/output circuit 260. The power supply potentials VDDQ and VSS supplied to the power supply terminals may be the same potentials as the power supply potentials VDD and VSS supplied to the power supply terminals in an embodiment of the disclosure. The power supply potentials VDDQ and VSS supplied to the power supply terminals may be different potentials from the power supply potentials VDD and VSS supplied to the power supply terminals in another embodiment of the disclosure. The power supply potentials VDDQ and VSS supplied to the power supply terminals are used for the input/output circuit 260 so that power supply noise generated by the input/output circuit 260 does not propagate to the other circuit blocks.

When a read command is received, and a row address and a column address are timely supplied with the read command, read data is read from memory cells in the memory array 250 corresponding to the row address and the column address. The read command is received by the command decoder 215, which provides internal commands so that read data from the memory array 250 is provided to the read/write amplifiers 255. The read data is output to outside from the data terminals DQ via the input/output circuit 260. The DQS_t and DQS_c clocks are provided externally from clock terminals for timing provision of the read data by the input/output circuit 260. The external terminals DQ include several separate terminals, each providing a bit of data synchronized with a clock edge of the DQS_t and DQS_c clocks.

When the write command is received, and a row address and a column address are timely supplied with the write command, write data supplied to the data terminals DQ is written to a memory cells in the memory array 250 corresponding to the row address and the column address. A data mask may be provided to the data terminals DM to mask portions of the data when written to memory. The write command is received by the command decoder 215, which provides internal commands so that the write data is received by input receivers in the input/output circuit 260. DQS_t and DQS_c clocks are also provided to the external clock terminals (e.g., by a controller) for timing the receipt of the write data by the input receivers of the input/output circuit 260. The write data is supplied via the input/output circuit 260 to the read/write amplifiers 255, and by the read/write amplifiers 255 to the memory array 250 to be written into the memory cell MC. As previously described, the external terminals DQ include several separate terminals. With reference to a write operation, each external terminal DQ concurrently receives a bit of data synchronized with a clock edge of the DQS_t and DQS_c clocks.

When a mode register read command is received, and a mode register address is timely supplied with the mode register read command, information is read from the mode register 230 corresponding to the mode register address. The information is output to outside from the data terminals DQ via the input/output circuit 260. When a mode register write command is received, and a mode register address is timely supplied with the mode register write command, information supplied to the data terminals DQ is written to the mode register 230 corresponding to the mode register address.

The semiconductor device 200 may include an auto power-down feature according to an embodiment of the disclosure. For example, in some embodiments of the disclosure, a power-down mode may be entered automatically for a specific command and/or sequence of commands. Example auto power-down circuits and features that may be included in the semiconductor device 200 in some embodiments of the disclosure are described. The specific command(s) causing entry of the power-down mode may be user configured, such as by setting memory device auto power-down configurations using the mode register.

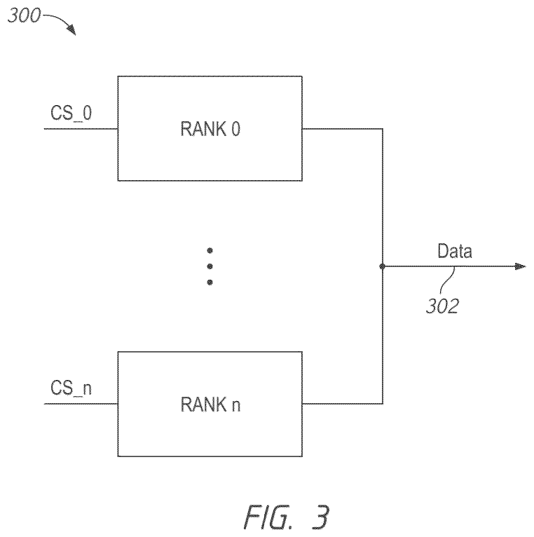

FIG. 3 illustrates a block diagram of certain features of an example memory module 300 according to an embodiment of the disclosure. A memory module can include one or more memory ranks. In the illustrated embodiment, the memory module 300 includes “n” memory ranks, where n is a number greater than one. Each memory rank may include one or more memory devices.

In some embodiments of the disclosure, the memory module includes semiconductor device 200 of FIG. 2. In some embodiments of the disclosure, the memory module is included in the memory system 104 of FIG. 1. Each memory rank is connected to a distinct chip select (CS_n) signal line and the output of each memory rank is connected to a data bus 302. For example, the memory devices of a memory rank may be connected to a common CS_n signal line and to the data bus 302. Which memory rank is able to transmit or receive data on the data bus 302 is controlled by a respective chip select signal. For example, when the memory rank 0 is to receive or output data, the chip select signal (CS_0) provided to the memory rank 0 transitions to an active signal level (e.g., a low or “0” state) and the remaining chip select signals are set to an inactive signal level (e.g., a high or “1” state). When data is to be input or output from another memory rank, the chip select signal provided to that memory rank transitions to an active signal level (e.g., a low or “0” state) and the chip select signal provided to the memory rank 0 (as well as any other chip select signals) is set to an inactive signal level (e.g., a high or “1” state). Which memory rank is transmitting or receiving data on the data bus 302 can be controlled in this manner.

During the operation of a memory module (e.g., a memory module with two or more ranks), the CA input buffers in the memory rank(s) that are not accessed may be shut down to reduce the power consumption of a system, for example, by entering a power-down mode for the memory devices included in the memory rank(s). The memory devices of the memory ranks include an auto power-down feature according to an embodiment of the disclosure. For example, in some embodiments of the disclosure, power-down may be entered for a specific command and/or sequence of commands, where the command is not an explicit power-down entry command. Example auto power-down circuits and features that may be included in the memory devices of the memory ranks in some embodiments of the disclosure is described. The specific command(s) causing automatic entry of the power-down mode may be user configured, such as by setting memory device auto power-down configurations using the mode register.

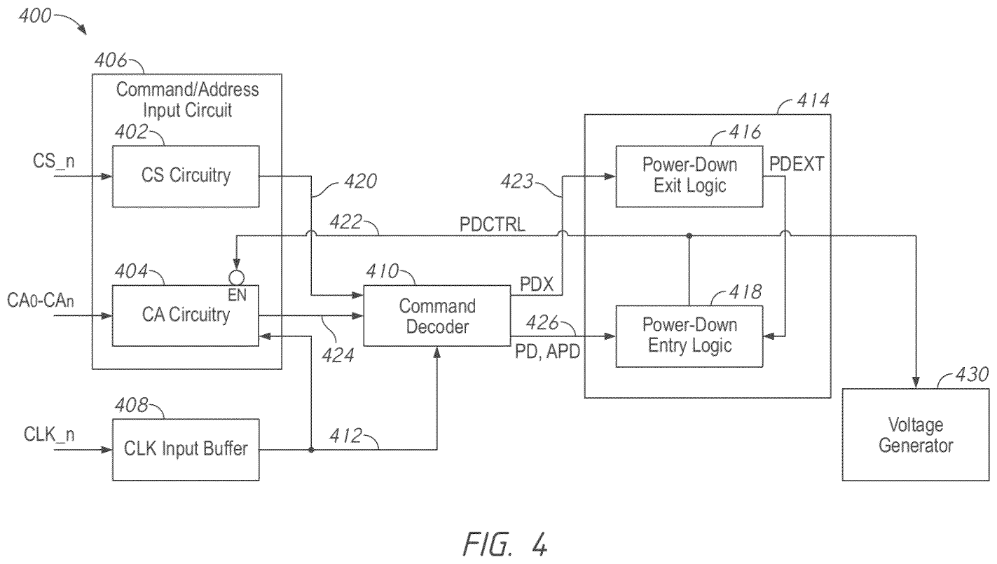

FIG. 4 illustrates a block diagram of example power-down circuitry 400 according to an embodiment of the disclosure. The power-down circuitry 400 provides internal power-down control signals that cause memory circuits to power down or to reduce power consumption by the circuits. In some embodiments, the memory circuits powered down include CA input buffers in a command/address input circuit (e.g., the command/address input circuit 205 of FIG. 2). In some embodiments, the memory circuits powered down additionally or alternatively include a voltage generator circuit (e.g., the internal voltage generator circuit 270 of FIG. 2). In some embodiments, the CA input buffers may be powered down completely (e.g., turned off completely) and the voltage generator can be powered down such that the output (e.g., voltage level) of the voltage generator circuit is reduced. For example, an internal regulated voltage and/or the voltage level provided to a WL can be lowered to reduce leakage current. In some implementations, the voltage level may be reduced by approximately two hundred (200) mV. Greater or lesser amounts of voltage level reductions can be implemented in other embodiments.

The power-down circuitry 400 includes CS circuitry 402 and CA circuitry 404 that may be included in a command/address input circuit 406. The CS circuitry 402 receives the CS_n signal, and the CA circuitry 404 receives the CA signals (e.g., the CAO-CAn signals). The command/address input circuit 406 can be implemented as the command/address input circuit 205 shown in FIG. 2 in some embodiments.

A clock (CLK) input buffer 408 receives one or more clock signals (e.g., CK_t and CK_c signals). The CLK input buffer 408 may provide an internal clock signal to the command/address input circuit 406 and a command decoder circuit 410 (via signal line 412). The CLK input buffer circuit 410 can be implemented as the CLK input buffer circuit 220 shown in FIG. 2, and the command decoder circuit 410 may be implemented as the command decoder circuit 215 of FIG. 2 in some embodiments.

The power-down circuitry 400 further includes a power-down controller circuit 414. The power-down controller circuit 414 includes power-down entry logic circuit 418 and power-down exit logic circuit 416. The power down controller circuit 414 may be implemented as the power-down controller 224 shown in FIG. 2 in some embodiments.

An output of the CS circuitry 402 is input into the command decoder circuit 410 via signal line 420. An output of the CA circuitry 404 is input into the command decoder circuit 410 on signal line 424. The command decoder circuit 410 provides internal power-down entry command signal PD and auto power-down signal APD to the power-down entry logic circuit 418 on signal line 426. The command decoder 410 may provide an active internal power-down entry command signal PD when an explicit power-down entry command is received by the command/address input circuit 406. An active internal auto power-down signal APD may be provided to the power-down controller 414 when auto power-down is enabled for one or more specific commands and the one or more specific commands is received by the command/address input circuit 406. In some embodiments, the PD and APD signals are the same signal, with an active PD/APD signal causing entry into power-down for an explicit power-down entry command received by the command/address input circuit 406 and/or for auto power-down when auto power-down is enabled for one or more specific commands and the one or more specific commands is received by the command/address input circuit 406.

An active PD/APD signal causes the power-down entry logic circuit 418 to provide a power-down control signal PDCTRL that is used to deactivate memory circuits for a power-down state. For example, the PDCTRL signal is provided by the power-down entry logic circuit 418 to the CA circuitry 404 having a logic state to deactivate and/or reduce power consumption by signal input buffers of the CA circuitry 404. In another example, the PDCTRL signal is provided by the power-down entry logic circuit 418 to the internal voltage generator circuit 430 having a logic state to deactivate and/or reduce power consumption (e.g., reduce output voltage level) by the internal voltage generator circuit 430. In some embodiments, the voltage generator circuit 430 may be implemented as the internal voltage generator circuit 270 shown in FIG. 2.

When a power-down exit command is received by the command/address input circuit 406, and corresponding internal commands are provided to the command decoder 410, the command decoder circuit 410 provides an active internal power-down exit command signal PDX to power-down exit logic circuit 416 on signal line 423. In response, the power-down exit logic circuit 416 provides an active control signal PDEXT to the power-down entry logic circuit 418 to change the logic state of the PDCTRL signal to activate memory circuits that were deactivated or placed in a reduced power consumption mode. For example, the PDCTRL signal is provided by the power-down entry logic circuit 418 to the CA circuitry 404 having another logic state to activate and/or return signal input buffers of the CA circuitry 404 to normal power consumption. In another example, the PDCTRL signal is provided by the power-down entry logic circuit 418 to the internal voltage generator circuit 430 having the other logic state to activate and/or return the internal voltage generator circuit 430 to normal power consumption (e.g., reduce output voltage level).

In some embodiments, a power-down exit command is represented by toggling or changing a logic state of a signal, for example, by toggling a chip select signal CS_n to a low logic level. In some embodiments of the disclosure, a power-down exit command may be an explicit power-down exit command received by the memory. For example, a no operation NOP command may cause exit from a power-down state in some embodiments. In some embodiments of the disclosure, a power-down exit command may be an auto power-down exit associated with a non-power-down exit command received by the memory.

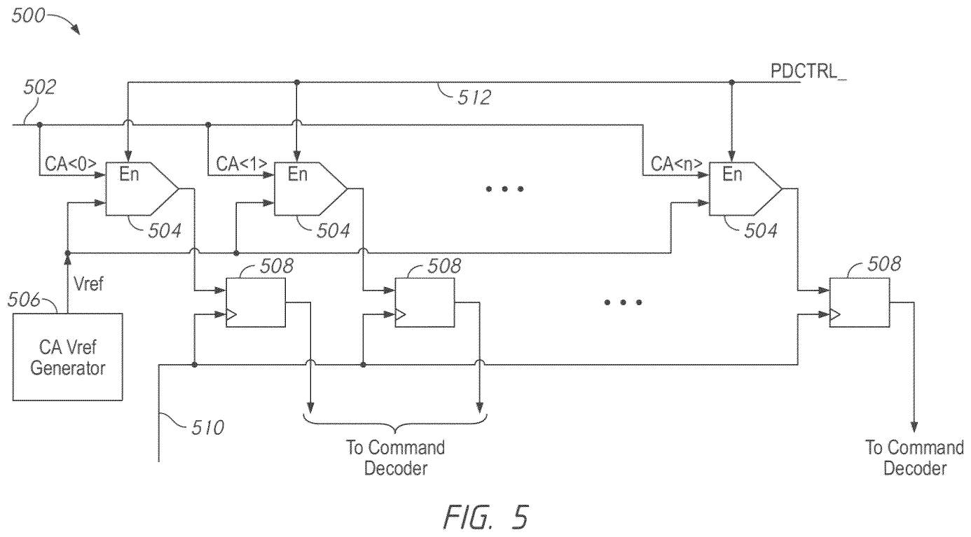

FIG. 5 illustrates a block diagram of example command address circuitry 500 according to an embodiment of the disclosure. The CA circuitry 500 are memory circuits that may be deactivated based on the assertion of the PDCTRL signal. The CA circuitry 500 may be implemented as the CA circuitry 404 of FIG. 4 in some embodiments. The CA circuitry 500 may be implemented as the signal input buffers 207 of FIG. 2 in some embodiments.

As CA signals are received by a memory device (e.g., memory devices 106 of FIG. 1, semiconductor device 200 of FIG. 2, and/or included in the memory module of FIG. 3) on signal line 502, the CA signals may be provided to a buffer stage including CA input buffers 504 prior to being decoded by a command decoder (e.g., command decoder 215 of FIG. 2). The CA input buffers 504 may compare the CA signals to a reference voltage (Vref) output by a CA voltage reference generator 506. The CA voltage reference generator 506 may be within an element of the memory device or included in a separate power supply. The Vref signal and the CA signals are compared to determine the signal level (e.g., a “high” or “low” state) of each CA signal. Once the signal level of a CA signal is known, the CA signal may be sent from each CA input buffer 504 to a respective latch 508. Each latch 508 receives a clock signal CLK on signal line 510 (e.g., ICLK signal of FIG. 2), and based on the clock signal, the latches 508 may control the timing of transmitting the CA signals to the command decoder.

In the illustrated embodiment, the PDCTRL_signal provided on signal line 512 is received by each of the CA input buffers 504 at an enable input (EN). The PDCTRL_signal is complementary to the PDCTRL signal shown in FIG. 4. The PDCTRL_signal is set to a first logic level to activate the CA input buffers 504, and to a second signal level to deactivate the CA input buffers 504. As previously described, during a power-down state when power-down has been entered, memory circuits, such as the CA input buffers 504, may be deactivated or have reduced power consumption in order to reduce overall power consumption by the memory. Upon exit from the power-down state, the deactivated memory circuits are activated and ready for operation.

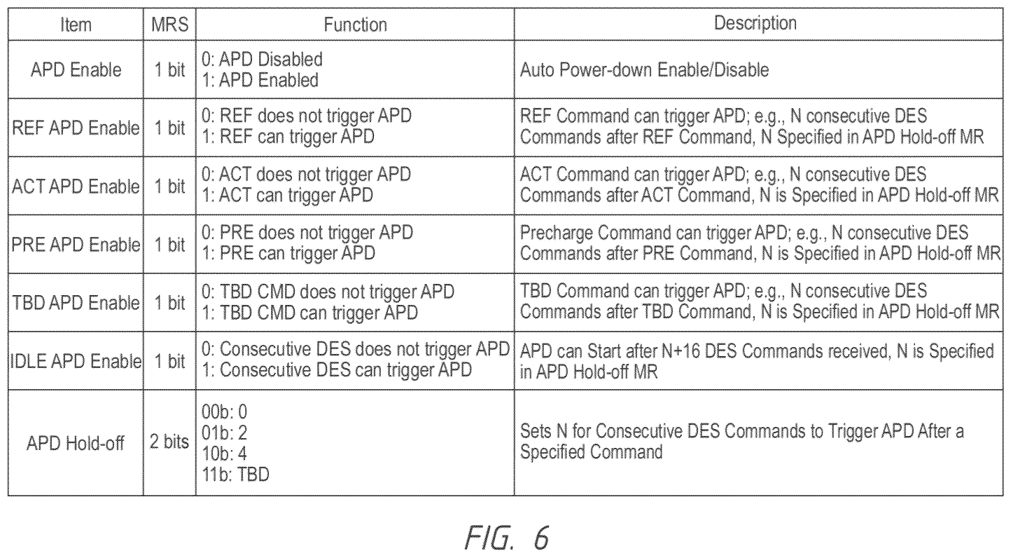

FIG. 6 is a table showing a mode register definition for an auto power-down feature according to an embodiment of the disclosure. In some embodiments of the disclosure, the mode register definition of FIG. 6 may be used for auto power-down features disclosed by the present disclosure. The mode register definition may be used to configure the auto power-down feature. In some embodiments, the mode register definition of FIG. 6 may be implemented in the memory devices 106 and memory system 104 of FIG. 1, the semiconductor device 200 of FIG. 2, the memory module 300 of FIG. 3, and/or the power-down circuitry 400 of FIG. 4. In the example of FIG. 6, the mode register definition includes 8 bits. The bits of the mode register definition may be set to a “0” or a “1” by a mode register write operation to the mode register assigned for the auto power-down feature.

As shown in the example of FIG. 6, one bit can be defined as an auto power-down enable bit APD Enable. When the APD Enable bit is set to “0” auto power-down is disabled for the memory, and when the APD Enable bit is set to “1” auto power-down is enabled for the memory. When enabled, the auto power-down feature may be used to execute entry into a power-down mode for particular commands received by the memory. The APD Enable bit is optional, and in some embodiments, the APD Enable bit is not included in the mode register definition.

As further shown in the example of FIG. 6, one bit can be defined to enable a refresh command REF as a trigger for entry into a power-down state, identified as REF APD Enable. When the REF APD Enable bit is set to “0” a REF command received by the memory will not cause the memory to enter a power-down state. When the REF APD Enable bit is set to “1” a REF command received by the memory will cause the memory to perform a refresh operation and enter a power down state. The REF command may be provided, for example, by a controller (e.g., controller 102 of FIG. 1). When REF APD is enabled, a REF command will trigger entry into a power-down state. As a result, a separate explicit power-down entry command is unnecessary to enter a power-down state after a REF command. Instead, a REF command will cause a refresh operation to be performed, and further cause entry into a power-down state. In some embodiments, entry into the power-down state occurs at a time relative to receipt of the REF command. For example, in the embodiment of FIG. 6, a hold-off value “N” sets a number of consecutive DES commands after which the power-down state is entered. As will be discussed in more detail below, the value of “N” may be set using other bits of the mode register definition.

FIG. 6 also shows that one bit can be defined to enable an activate command ACT as a trigger for entry into a power-down state, identified as ACT APD Enable. When the ACT APD Enable bit is set to “0” an ACT command received by the memory will not cause the memory to enter a power-down state. When the ACT APD Enable bit is set to “1” an ACT command received by the memory will cause the memory to perform an activate operation and enter a power down state. The ACT command may be provided, for example, by a controller (e.g., controller 102 of FIG. 1). When ACT APD is enabled, an ACT command will trigger entry into a power-down state. As a result, a separate explicit power-down entry command is unnecessary to enter a power-down state after an ACT command. Instead, an ACT command will cause an activate operation to be performed, and further cause entry into a power-down state. In some embodiments, entry into the power-down state occurs at a time relative to receipt of the ACT command. For example, in the embodiment of FIG. 6, a hold-off value “N” sets a number of consecutive DES commands after which the power-down state is entered. As will be discussed in more detail below, the value of value “N” may be set using other bits of the mode register definition. Using the ACT command to trigger auto power-down entry may reduce active standby current by automatic transition from IDD3N to IDD3P (e.g., IDD3N).

FIG. 6 also shows that one bit can be defined to enable a precharge command PRE as a trigger for entry into a power-down state, identified as PRE APD Enable. When the PRE APD Enable bit is set to “0” a PRE command received by the memory will not cause the memory to enter a power-down state. When the PRE APD Enable bit is set to “1” a PRE command received by the memory will cause the memory to perform a precharge operation and enter a power down state. The PRE command may be provided, for example, by a controller (e.g., controller 102 of FIG. 1). When PRE APD is enabled, a PRE command will trigger entry into a power-down state. As a result, a separate explicit power-down entry command is unnecessary to enter a power-down state after a PRE command. Instead, a PRE command will cause a precharge operation to be performed, and further cause entry into a power-down state. In some embodiments, entry into the power-down state occurs at a time relative to receipt of the PRE command. For example, in the embodiment of FIG. 6, a hold-off value “N” sets a number of consecutive DES commands after which the power-down state is entered. As will be discussed in more detail below, the value of value “N” may be set using other bits of the mode register definition. Using the PRE command to trigger auto power-down entry may reduce standby current by automatic transition from IDD2N to IDD2P (e.g., IDD2N).

FIG. 6 also shows that one bit can be defined to enable a “to-be-determined” command TBD as a trigger for entry into a power-down state, identified as TBD APD Enable. The to-be-determined command provides flexibility for using another memory command to cause entry into a power-down state. The TBD command includes memory commands that are currently known, as well as later developed memory commands. When the TBD APD Enable bit is set to “0” a TBD command received by the memory will not cause the memory to enter a power-down state. When the TBD APD Enable bit is set to “1” a TBD command received by the memory will cause the memory to perform an operation for the TBD command and enter a power down state. A TBD command may be provided, for example, by a controller (e.g., controller 102 of FIG. 1). When TBD APD is enabled, a TBD command will trigger entry into a power-down state. As a result, a separate explicit power-down entry command is unnecessary to enter a power-down state after a TBD command. Instead, a TBD command will cause a to-be-determined operation to be performed, and further cause entry into a power-down state. In some embodiments, entry into the power-down state occurs at a time relative to receipt of the TBD command. For example, in the embodiment of FIG. 6, a value “N” sets a number of consecutive DES commands after which the power-down state is entered. As will be discussed in more detail below, the value of “N” may be set using other bits of the mode register definition.

FIG. 6 also shows that one bit can be defined to enable entry into a power-down state after an idle period, identified as IDLE APD Enable. When the IDLE APD Enable bit is set to “0” the memory does not enter a power-down state following receipt of a number of consecutive deselect commands DES, and when the IDLE APD Enable is set to “1” the memory enters a power-down state following receipt of the number of consecutive DES commands. In some embodiments, the number of consecutive DES commands may be, at least in part, defined by other bits defined by the mode register definition. For example, in the embodiment of FIG. 6, the number of consecutive DES commands is defined as the sum of a hold-off value and a fixed number, such as, as shown in FIG. 6, the number of consecutive DES commands may be the sum of the hold-off value “N” and fixed number 16 (e.g., N+16) consecutive DES commands. As will be discussed in more detail below, the hold-off value of “N” may be set using other bits of the mode register definition. Additionally, the fixed number 16 is provided as an example, and in other embodiments, the fixed number may be different. When IDLE APD is enabled, a power-down state will be entered after the number of consecutive DES commands is received by the memory. As a result, a separate explicit power-down entry command is unnecessary to enter a power-down state. Instead, receiving the number of consecutive DES commands will cause entry into power-down.

As further shown in the example of FIG. 6, two bits can be defined to set a hold-off value that may be used for another defined auto power-down feature, such as defining “N.” The two bits are identified in FIG. 6 as APD Hold-off. When the bits of APD Hold-off are set to “00”, the value for N is set to 0. When the bits of APD Hold-off are set to “01”, the value for N is set to 2. When the bits of APD Hold-off are set to “10”, the value for N is set to 4. The value for N when the bits of APD Hold-off are set to “11”, may be “to-be-determined,” which provides flexibility for defining another value that is different than 0, 2, or 4, or sets another option for the hold-off value. In the example of FIG. 6, the APD Hold-off is set for a deselect command DES. In some embodiments, the Hold-off may be for consecutive DES commands. However, in some embodiments, the Hold-off may be for a number of DES commands, even if other commands are received to interrupt the number of DES commands. In some embodiments, the Hold-off may be applied to a different command.

A power-down state triggered by an auto power-down command may be exited in response to a power-down exit command. In some embodiments of the disclosure, the power-down exit command can cause exit from a power-down state entered by an explicit power-down entry command, and also from a power-down state entered by an auto power-down command. In some embodiments of the disclosure, a power-down exit command is represented by toggling or changing a logic state of a signal, for example, by toggling a chip select CS_n signal to a low logic level. In some embodiments of the disclosure, a power-down exit command may be an explicit power-down exit command received by the memory. For example, a no operation NOP command may cause exit from a power-down state. In some embodiments of the disclosure, a power-down exit command may be an auto power-down exit associated with a non-power-down exit command received by the memory.

In some embodiments of the disclosure, non-target on-die termination (NT ODT) may be handled the same as for power-down entry from an explicit power-down entry command.

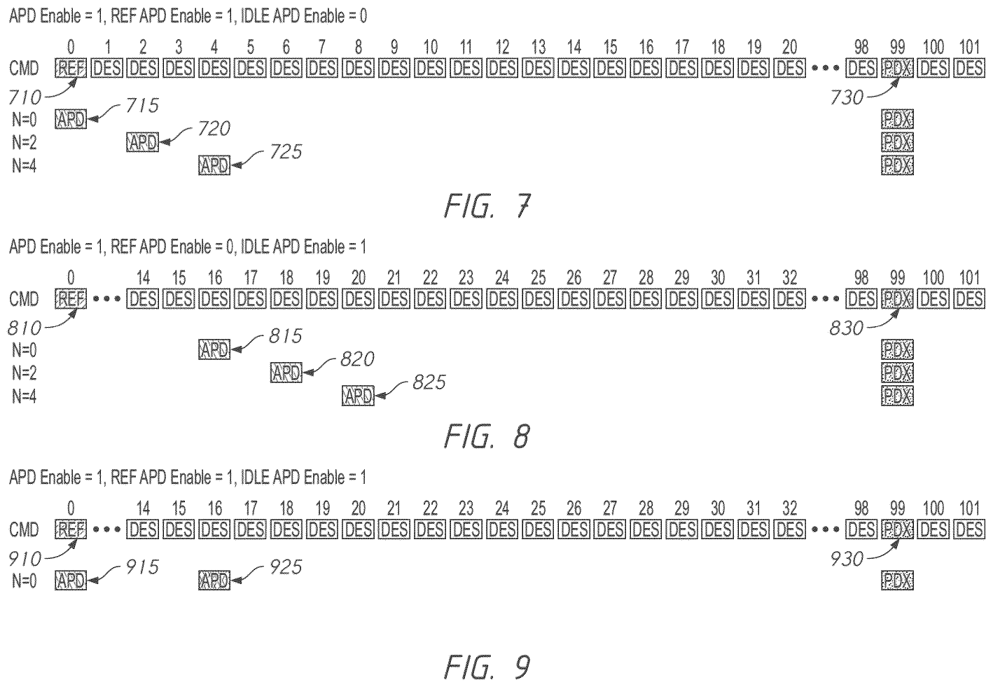

FIG. 7 is a diagram showing the timing of an auto power-down entry according to an embodiment of the disclosure. In some embodiments, the mode register definition of FIG. 6 may be applied to the timing of the auto power-down entry of FIG. 7. FIG. 7 will be described with reference to the example of FIG. 6. However, the embodiment of FIG. 6 is not limited to the timing shown in FIG. 7, and the timing of FIG. 7 is not limited to the particular example of the mode register definition of FIG. 6.

The diagram of FIG. 7 shows commands CMD received by a memory, as well as the timing of a power-down mode relative to a command for different APD Hold-off values. The commands CMD, may be provided by a controller (e.g., controller 102 of FIG. 1). The example of FIG. 7 assumes that APD Enable=1 (APD enabled), REF APD Enable=1 (REF command can trigger APD), and IDLE APD Enable-0 (consecutive DES command does not trigger APD).

At command period 0, a REF command 710 is received by a memory. Because REF APD is enabled, a REF command will cause a refresh operation to be performed, and can further trigger entry into a power-down state. When the APD Hold-off is 00b to set the value of N to 0, in response to the REF command received at command period 0, the power-down state is entered as shown by the auto power-down entry APD 715 at command period 0, which is 0 command periods after the REF command. In contrast, when the APD Hold-off is 01b to set the value of N to 2, in response to the REF command received at command period 0, the power-down state is entered as shown by the auto power-down entry APD 720 at command period 2, which is the 2nd command period after the REF command. When the APD Hold-off is 10b to set the value of N to 4, in response to the REF command received at command period 0, the power-down state is entered as shown by the auto power-down entry APD 725 at command period 4, which is the 4th command period after the REF command. DES commands are received by the memory at command periods 1 thru 98. At command period 99, a PDX power-down exit command 730 is received by the memory, causing the power-down state to be exited for any of the APD Hold-off settings.

FIG. 8 is a diagram showing the timing of an auto power-down entry according to an embodiment of the disclosure. In some embodiments, the mode register definition of FIG. 6 may be applied to the timing of the auto power-down entry of FIG. 8. FIG. 8 will be described with reference to the example of FIG. 6. However, the embodiment of FIG. 6 is not limited to the timing shown in FIG. 8, and the timing of FIG. 8 is not limited to the particular example of the mode register definition of FIG. 6.

The diagram of FIG. 8 shows commands CMD received by a memory, as well as the timing of a power-down mode relative to a command for different APD Hold-off values. The commands CMD, may be provided by a controller (e.g., controller 102 of FIG. 1). The example of FIG. 8 assumes that APD Enable=1 (APD enabled), REF APD Enable-0 (REF command does not trigger APD), and IDLE APD Enable=1 (consecutive DES commands can trigger APD).

At command period 0, a REF command 810 is received by a memory. Des commands are received by the memory for command periods 2-98. Because REF APD is disabled, a REF command will cause a refresh operation to be performed, but does not trigger entry into a power-down state. Instead, with IDLE APD enabled, power-down is triggered following a number of consecutive DES commands. In the example of FIG. 8, power-down is triggered following N+16 consecutive DES commands. As a result, when the APD Hold-off is 00b to set the value of N to 0, in response to (0+16) consecutive DES commands the power-down state is entered as shown by the auto power-down entry APD 815 at command period 16, which is the 16th consecutive DES command. In contrast, when the APD Hold-off is 01b to set the value of N to 2, in response to (2+16) consecutive DES commands, the power-down state is entered as shown by the auto power-down entry APD 820 at command period 18, which is the 18th consecutive DES command. When the APD Hold-off is 10b to set the value of N to 4, in response to (4+16) consecutive DES commands, the power-down state is entered as shown by the auto power-down entry APD 825 at command period 20, which is the 20th consecutive DES command. At command period 99, a PDX power-down exit command 830 is received by the memory, causing the power-down state to be exited for any of the APD Hold-off settings.

FIG. 9 is a diagram showing the timing of an auto power-down entry according to an embodiment of the disclosure. In some embodiments, the mode register definition of FIG. 6 may be applied to the timing of the auto power-down entry of FIG. 9. FIG. 9 will be described with reference to the example of FIG. 6. However, the embodiment of FIG. 6 is not limited to the timing shown in FIG. 9, and the timing of FIG. 9 is not limited to the particular example of the mode register definition of FIG. 6.

The diagram of FIG. 9 shows commands CMD received by a memory, as well as the timing of a power-down mode relative to a command for an APD Hold-off of N=0. The commands CMD, may be provided by a controller (e.g., controller 102 of FIG. 1). The example of FIG. 9 assumes that APD Enable=1 (APD enabled), REF APD Enable=1 (REF command can trigger APD), and IDLE APD Enable=1 ((0+16) DES commands can trigger APD).

At command period 0, a REF command 910 is received by a memory. Because REF APD is enabled, a REF command will cause a refresh operation to be performed, and can further trigger entry into a power-down state. In the example of FIG. 9, with APD Hold-off at 00b to set the value of N to 0, in response to the REF command received at command period 0, the power-down state is entered as shown by the auto power-down entry APD 915 at command period 0, which is 0 command periods after the REF command. In some embodiments, APD will not be triggered when the memory is already in power-down or a power-down entry. For example, although IDLE APD is enabled, as previously described for the example, a power-down trigger 925 for (0+16) consecutive DES commands at command period 16 is effectively ignored because the memory is already in a power-down state or entering a power-down state from the auto power-down entry 915 resulting from the REF command 910 at command period 0. At command period 99, a PDX power-down exit command 930 is received by the memory, causing the power-down state to be exited.

The example of FIG. 9 illustrates the interaction of multiple auto power-down commands according to some embodiments of the disclosure. While both REF APD and IDLE APD are enabled, in the example of FIG. 9, the REF command 910 received by the memory at command period 0 causes entry into a power-down state. Since the memory entered the power-down state at command period 0 and remained in the power-down state, the auto power-down trigger 925 associated with IDLE APD at command period 16 does not affect the power-down state of the memory. The memory continues to remain in the power-down state until exited by the PDX command 930 at command period 99.

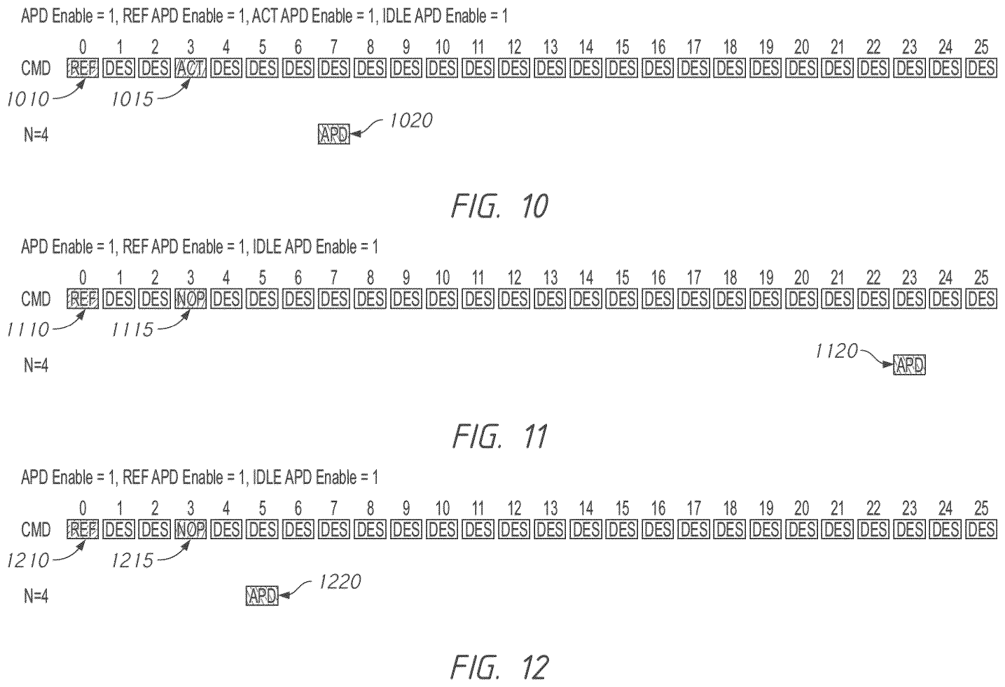

FIG. 10 is a diagram showing the timing of an auto power-down entry according to an embodiment of the disclosure. In some embodiments, the mode register definition of FIG. 6 may be applied to the timing of the auto power-down entry of FIG. 10. FIG. 10 will be described with reference to the example of FIG. 6. However, the embodiment of FIG. 6 is not limited to the timing shown in FIG. 10, and the timing of FIG. 10 is not limited to the particular example of the mode register definition of FIG. 6.

The diagram of FIG. 10 shows commands CMD received by a memory, as well as the timing of a power-down mode relative to a command for an APD Hold-off of N=4. The commands CMD, may be provided by a controller (e.g., controller 102 of FIG. 1). The example of FIG. 10 assumes that APD Enable=1 (APD enabled), REF APD Enable=1 (REF command can trigger APD), ACT APD Enable=1 (ACT command can trigger APD), and IDLE APD Enable=1 ((4+16) DES commands can trigger APD).

At command period 0, a REF command 1010 is received by a memory. Because REF APD is enabled, a REF command 1010 will cause a refresh operation to be performed, and can further trigger entry into a power-down state. With the APD Hold-off set to 10b to set the value of N to 4, as previously described for the example, a power-down state could be entered at command period 4, which is the 4th command period after the REF command 1010. However, an ACT command 1015 is received by the memory at command period 3, before power-down entry from the REF command 1010. The ACT command 1015 interrupts the auto power-down trigger of the REF command 1010 because the ACT command 1015 is received before entry into a power-down state based on the REF command 1010. As a result, the memory does not enter a power-down state at command period 4 from the REF command 1010.

The ACT command 1015 received at command period 3 also interrupts the auto power-down trigger of IDLE APD because consecutive DES commands are interrupted by the ACT command 1015. Due to the interruption of consecutive DES commands, the counting of consecutive DES commands for the IDLE APD restarts at command period 4. For example, the DES command at command period 4 is a first DES command, and the DES command at command period 5 is a second DES command, and so on.

Recall that ACT APD is enabled, and as a result, the ACT command 1015 will cause an activate operation to be performed, and can further trigger entry into a power-down state. With N=4 set by APD Hold-off 10b, in response to the ACT command 1015 received at command period 3, the power-down state is entered as shown by the auto power-down entry APD 1020 at command period 7, which is the 4th command period after the ACT command 1015.

Although IDLE APD is enabled, as previously described for the example, a power-down trigger for (4+16) DES commands (not shown in FIG. 10) is effectively ignored because the memory is already in a power-down state from the auto power-down entry 1020 resulting from the ACT command 1015 at command period 3.

The example of FIG. 10 illustrates the interaction of multiple auto power-down commands according to some embodiments of the disclosure. In FIG. 10, auto-power down entry for the REF command 1010, and for IDLE APD are interrupted by another command, namely, the ACT command 1015. Interrupting IDLE APD causes the counting of consecutive DES commands to restart.

FIG. 11 is a diagram showing the timing of an auto power-down entry according to an embodiment of the disclosure. In some embodiments, the mode register definition of FIG. 6 may be applied to the timing of the auto power-down entry of FIG. 11. FIG. 11 will be described with reference to the example of FIG. 6. However, the embodiment of FIG. 6 is not limited to the timing shown in FIG. 11, and the timing of FIG. 11 is not limited to the particular example of the mode register definition of FIG. 6.

The diagram of FIG. 11 shows commands CMD received by a memory, as well as the timing of a power-down mode relative to a command for an APD Hold-off of N=4. The commands CMD, may be provided by a controller (e.g., controller 102 of FIG. 1). The example of FIG. 11 assumes that APD Enable=1 (APD enabled), REF APD Enable=1 (REF command can trigger APD), and IDLE APD Enable=1 ((4+16) DES commands can trigger APD).

At command period 0, a REF command 1110 is received by a memory. Because REF APD is enabled, a REF command 1110 will cause a refresh operation to be performed, and can further trigger entry into a power-down state. With the APD Hold-off set to 10b to set the value of N to 4, as previously described for the example, a power-down state could be entered at command period 4, which is the 4th command period after the REF command 1110. However, a no operation NOP command 1115 is received by the memory at command period 3, before power-down entry from the REF command 1110. The NOP command 1115 interrupts the auto power-down trigger of the REF command 1110 because the NOP command 1115 is received before entry into a power-down state based on the REF command 1110. As a result, the memory does not enter a power-down state at command period 4 from the REF command 1110.

The NOP command 1115 received at command period 3 also interrupts the auto power-down trigger of IDLE APD because consecutive DES commands are interrupted by the NOP command 1115. Due to the interruption of consecutive DES commands, the counting of consecutive DES commands for the IDLE APD restarts at command period 4. For example, the DES command at command period 4 is a first DES command, and the DES command at command period 5 is a second DES command, and so on. With no other interruptions in the DES commands following the NOP command 1115 at command period 3, the power-down state is entered as shown by the auto power-down entry APD 1120 at command period 23, which is the 20th consecutive DES command following the NOP command 1115.

The example of FIG. 11 illustrates the interaction of multiple auto power-down commands according to some embodiments of the disclosure. In FIG. 11, auto-power down entry for the REF command 1110, and for IDLE APD are interrupted by another command, namely, the NOP command 1115. Interrupting IDLE APD causes the counting of consecutive DES commands to restart. In the example of FIG. 11, power-down is entered for the 20th consecutive DES command following the restart of counting DES commands.

In some embodiments of the disclosure, interrupting a command APD (e.g., REF APD) causes cancellation of APD related to the command (e.g., REF command 1110). That is, once interrupted, auto power-down entry related to a command will not occur. FIG. 11 illustrates such an example embodiment.

In some embodiments of the disclosure, interrupting a command APD causes a delay of APD related to the command. Even if other commands are received before entry of power-down for the command APD, APD entry related to the command APD occurs when the N count of DES commands is met. An example embodiment is illustrated by FIG. 12.

FIG. 12 is a diagram showing the timing of an auto power-down entry according to an embodiment of the disclosure. In some embodiments, the mode register definition of FIG. 6 may be applied to the timing of the auto power-down entry of FIG. 12. FIG. 12 will be described with reference to the example of FIG. 6. However, the embodiment of FIG. 6 is not limited to the timing shown in FIG. 12, and the timing of FIG. 12 is not limited to the particular example of the mode register definition of FIG. 6.

The diagram of FIG. 12 shows commands CMD received by a memory, as well as the timing of a power-down mode relative to a command for an APD Hold-off of N=4. The commands CMD, may be provided by a controller (e.g., controller 102 of FIG. 1). The example of FIG. 12 assumes that APD Enable=1 (APD enabled), REF APD Enable=1 (REF command can trigger APD), and IDLE APD Enable=1 ((4+16) DES commands can trigger APD).

At command period 0, a REF command 1210 is received by a memory. Because REF APD is enabled, a REF command 1210 will cause a refresh operation to be performed, and can further trigger entry into a power-down state. With the APD Hold-off set to 10b to set the value of N to 4, as previously described for the example, a power-down state could be entered at command period 4, which is the 4th command period after the REF command 1210. However, a no operation NOP command 1215 is received by the memory at command period 3. The NOP command 1215 interrupts the auto power-down trigger of the REF command 1210 because the NOP command 1215 is received before entry into a power-down state based on the REF command 1210. As a result, the memory does not enter a power-down state at command period 4 for the REF command 1210.

The NOP command 1215 received at command period 3 also interrupts the auto power-down trigger of IDLE APD because consecutive DES commands are interrupted by the NOP command 1215. Due to the interruption of consecutive DES commands, the counting of consecutive DES commands for the IDLE APD restarts at command period 4. For example, the DES command at command period 4 is a first DES command, and the DES command at command period 5 is a second DES command, and so on. However, in some embodiments of the disclosure, the auto power-down trigger of IDLE APD may be delayed by the NOP command 1215, rather than the NOP command 1215 restarting the count of consecutive DES commands. For example, the auto power-down trigger of IDLE APD may continue counting DES commands even if other commands interrupt the count of DES commands, and enter a power-down state for (4+16) DES commands, if the memory is not already in a power-down state.

Although the NOP command 1215 interrupts the auto power-down trigger of the REF command 1210, a power-down state is entered as shown by the auto power-down entry APD 1220 at command period 5. The NOP command 1215 delays entry into the power-down state for the REF command 1210 by one command period, from command period 4 to command period 5. Command period 5 corresponds to a fourth DES command following the REF command 1210.

Although IDLE APD is enabled, as previously described for the example, a power-down trigger for (4+16) DES commands (not shown in FIG. 12) is effectively ignored because the memory is already in a power-down state from the auto power-down entry 1220 resulting from the REF command 1210 at command period 0.

The example of FIG. 12 illustrates the interaction of multiple auto power-down commands according to some embodiments of the disclosure. In FIG. 12, auto-power down entry for the REF command 1210, and for IDLE APD are interrupted by another command, namely, the NOP command 1215. However, rather than cancelling auto power-down entry for the REF command 1210, entry into a power-down state for the REF command 1210 is delayed. In some embodiments, the auto power-down entry for a command APD is delayed by the number of command periods corresponding to the number of interrupting commands. For example, in FIG. 12, the auto power-down entry for the REF command 1210 is delayed by one command period corresponding to the one command period of the NOP command 1215. The auto power-down entry for a command APD may be further delayed by including a greater number of interrupting commands.

FIGS. 7-12 are non-limiting examples according to some embodiments of the disclosure. The specific commands described in the examples are not intended to limit the scope of the disclosure to the specific commands and interactions. For example, the example of FIG. 9 is not intended to limit the scope of the disclosure to the interaction of a refresh auto power-down command with an idle auto power-down. Other auto power-down commands may interact with an idle auto power-down without departing from the scope of the disclosure. Similarly, the example of FIG. 10 is not intended to limit the scope of the disclosure to the interaction of a refresh auto power-down command with an activate auto power-down command. Other auto power-down commands may interact as described with reference to the example of FIG. 10.

Embodiments of the disclosure include apparatuses and methods that include various combinations of the auto power-down commands previously described. For example, embodiments of the disclosure include apparatuses and methods that include one or more of the auto power-down commands previously described with reference to FIGS. 6-12, and to a greater extent, described with reference to any of the Figures or described in the previous disclosure.

The foregoing description, for purposes of explanation, uses specific nomenclature to provide a thorough understanding of the described embodiments. However, it will be apparent to one skilled in the art that the specific details are not required to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. An apparatus, comprising:
a command/address input circuit configured to receive memory commands and configured to provide internal input command signals based on the memory commands;
a memory array including a plurality of memory cells configured to store data;
memory array circuits coupled to the memory array and configured to perform memory array operations on the memory cells of the memory array;
memory circuits configured to perform memory circuit operations when activated and configured to have reduced power consumption when deactivated;
a command decoder coupled to the command/address input circuit and configured to receive the internal input command signals, decode the internal input command signals, and provide internal command signals to cause the memory array circuits to perform memory array operations on the memory cells of the memory array and further provide internal power-down command signals to cause entry to a power-down state; and
a power-down controller circuit coupled to the command decoder and configured to receive the internal power-down command signals and provide power-down control signals to deactivate the memory circuits.

2. The apparatus of claim 1 wherein the memory array circuits comprise a plurality of signal input buffer circuits included in the command/address input circuit, the plurality of signal input buffer circuits configured to receive memory command signals of the memory commands when activated, and configured to be deactivated based on the power-down control signals.

3. The apparatus of claim 2 wherein the memory array circuits comprise a second plurality of signal input buffer circuits included in the command/address input circuit, the second plurality of signal input buffer circuits configured to remain activated during the power-down state.

4. The apparatus of claim 2 wherein the memory array circuits further comprise a voltage generator circuit configured to generate one or voltages when activated, and configured to be deactivated based on the power-down control signals.

5. The apparatus of claim 2 wherein the memory array circuits further comprise a voltage generator circuit configured to generate one or voltages having active voltage levels when activated, and configured to generate the one or voltages having lower voltage levels than respective active voltage levels when deactivated based on the power-down control signals.

6. The apparatus of claim 1 wherein:
the command/address input circuit is configured to receive a refresh command as the memory command and configured to provide internal refresh input command signals based on the refresh command;
the command decoder is configured to receive the internal refresh input command signals as the internal input command signals and to decode the internal refresh input command signals to provide internal command signals to cause the memory array circuits to refresh memory cells of the memory array, the command decoder further configured to provide an active internal power-down command signal to cause power-down entry; and
the power-down controller circuit configured to receive the active internal power-down command signal and provide the power-down control signals to deactivate the memory circuits responsive to the active internal power-down command signal.

7. The apparatus of claim 1 wherein:
the command/address input circuit is configured to receive an activate command as the memory command and configured to provide internal activate input command signals based on the activate command;
the command decoder is configured to receive the internal activate input command signals as the internal input command signals and to decode the internal activate input command signals to provide internal command signals to cause the memory array circuits to activate memory cells of the memory array, the command decoder further configured to provide an active internal power-down command signal to cause power-down entry; and
the power-down controller circuit configured to receive the active internal power-down command signal and provide the power-down control signals to deactivate the memory circuits responsive to the active internal power-down command signal.

8. The apparatus of claim 1 wherein:
the command/address input circuit is configured to receive a precharge command as the memory command and configured to provide internal precharge input command signals based on the precharge command;
the command decoder is configured to receive the internal precharge input command signals as the internal input command signals and to decode the internal precharge input command signals to provide internal command signals to cause the memory array circuits to precharge memory cells of the memory array, the command decoder further configured to provide an active internal power-down command signal to cause power-down entry; and
the power-down controller circuit configured to receive the active internal power-down command signal and provide the power-down control signals to deactivate the memory circuits responsive to the active internal power-down command signal.

9. The apparatus of claim 1 wherein:
the command/address input circuit is configured to receive consecutive deselect commands as the memory command and configured to provide internal deselect input command signals based on the deselect commands;
the command decoder is configured to receive the internal deselect input command signals as the internal input command signals and to decode the internal deselect input command signals to provide an active internal power-down command signal to cause power-down entry; and
the power-down controller circuit configured to receive the active internal power-down command signal and provide the power-down control signals to deactivate the memory circuits responsive to the active internal power-down command signal.

10. A method for entering power-down for a memory device, comprising:
receiving at the memory device a command to perform a memory operation;
when auto power-down for the command is not enabled by a mode register setting:
performing the memory operation in response to the command; and
when auto power-down for the command is enabled by the mode register setting:
performing the memory operation in response to the command; and
entering power-down in response to the command.

11. The method of claim 10 wherein entering power-down in response to the command occurs at a number of second commands following receipt of the command.

12. The method of claim 11 wherein the number of second commands is programmed in a mode register as a second mode register setting.

13. The method of claim 11 wherein the second commands comprise consecutive deselect commands.

14. The method of claim 11 wherein the second commands comprise deselect commands.

15. The method of claim 10 wherein the command received by the memory device comprises a command for a memory array operation.

16. The method of claim 10 wherein the command received by the memory device comprises a refresh command to refresh memory cells of the memory device.

17. The method of claim 10 wherein the command received by the memory device comprises an activate command to activate memory cells of the memory device.

18. The method of claim 10 wherein the command received by the memory device comprises a precharge command to precharge memory array circuits of the memory device.

19. The method of claim 10 wherein the command received by the memory device comprises a plurality of consecutive deselect commands to deselect the memory device.

20. An apparatus, comprising:
a command/address input circuit configured to receive memory commands and configured to provide internal input command signals based on the memory commands;
memory circuits configured to perform memory circuit operations when activated and configured to have reduced power consumption when deactivated;
a mode register including mode register settings for auto power-down;
a command decoder coupled to the command/address input circuit and configured to receive the internal input command signals and decode the internal input command signals, and further configured to:
provide internal command signals to perform an operation in response to the internal input command signals when auto power-down is not enabled by the mode register settings in the mode register, and
provide the internal command signals to perform the operation in response to the internal input command signals and further provide active internal power-down command signals when auto power-down is enabled by the mode register settings in the mode register; and
a power-down controller circuit coupled to the command decoder and configured to receive the internal power-down command signals and provide power-down control signals to control activation and deactivation of the memory circuits.

21. The apparatus of claim 20 wherein the mode register settings in the mode register for the auto power-down comprises a mode register setting to enable and disable auto power-down for a refresh command.

22. The apparatus of claim 20 wherein the mode register settings in the mode register for the auto power-down comprises a mode register setting to enable and disable auto power-down for an activate command.

23. The apparatus of claim 20 wherein the mode register settings in the mode register for the auto power-down comprises a mode register setting to enable and disable auto power-down for a precharge command.

24. The apparatus of claim 20 wherein the mode register settings in the mode register for the auto power-down comprises a mode register setting to enable and disable auto power-down for a number of consecutive deselect commands.

25. The method of claim 20 wherein the mode register settings in the mode register for the auto power-down comprises a mode register setting to set a hold-off value for auto power-down.

26. A system, comprising:
a controller configured to provide a memory command;
command/address bus coupled to the controller and configured to transmit the memory command;
a data bus configure to transmit data;
a memory system coupled to the controller by the command/address bus and the data bus, the memory system including at least one memory device configured to receive data from and provide data to the controller, the memory device further configured to:
when auto power-down for the memory command is not enabled by a mode register setting set by the controller:
perform a memory operation in response to the memory command; and
when auto power-down for the memory command is enabled by the mode register setting set by the controller:
perform the memory operation in response to the memory command and enter a power-down in response to the memory command.

27. The system of claim 26 wherein the controller is configured to set an auto power-down configuration in the mode register to enable a refresh auto power-down, and the memory device of the memory system is configured to perform a refresh operation in response to a refresh command from the controller and to further enter the power-down in response to the refresh command.

28. The system of claim 26 wherein the controller is configured to set an auto power-down configuration in the mode register to enable an activate auto power-down, and the memory device of the memory system is configured to perform an activate operation in response to an activate command from the controller and to further enter the power-down in response to the activate command.

29. The system of claim 26 wherein the controller is configured to set an auto power-down configuration in the mode register to enable a precharge auto power-down, and the memory device of the memory system is configured to perform a precharge operation in response to a precharge command from the controller and to further enter the power-down in response to the precharge command.

30. The system of claim 26 wherein the controller is configured to set an auto power-down configuration in the mode register to enable auto power-down for a number of consecutive deselect commands, and the memory device of the memory system is configured to be deselected in response to a deselect command from the controller and to further enter the power-down in response to the number of consecutive deselect commands.

31. The system of claim 26 wherein the controller is configured to set a hold-off value in the mode register to set a number of deselect commands from the memory command for entry to power-down.

32. A method, comprising:
setting in a mode register of a memory a mode register setting for auto power-down to enable entry to a power-down state in response to a memory command;
providing the memory command to the memory to cause the memory to perform a memory operation corresponding to the memory command and to further cause the memory to enter the power-down state in response to the memory command.

33. The method of claim 32, further comprising setting in the mode register of the memory a hold-off setting for auto power-down for a number of deselect commands from the memory command for entry to power-down, and wherein the memory is caused to enter the power-down state the number of deselect commands following the memory command.

34. The method of claim 32 wherein setting in the mode register of the memory the mode register setting for auto power-down comprises setting the mode register setting for auto power-down to enable entry to the power-down state in response to refresh commands, and wherein providing the memory command to the memory comprises providing a refresh command to cause the memory to perform a refresh operation and to further cause the memory to enter the power-down state.

35. A method, comprising:
receiving a first command having auto power-down enabled;
performing a first operation in response to the first command;
entering power-down in response to the first command;
receiving a second command having auto-power-down enabled;
performing a second operation in response to the second command; and
remaining in power-down from power-down entry in response to the first command.

36. The method of claim 35 wherein the first command comprises a refresh command and wherein the second command comprises a deselect command.

37. A method, comprising:
receiving a first command having auto power-down enabled;
performing a first operation in response to the first command;
before entry to power-down in response to the first command, receiving a second command having auto-power-down enabled;
interrupting power-down entry in response to the first command;
performing a second operation in response to the second command; and
entering power-down after receiving the second command.

38. The method of claim 37 wherein the first command comprises a refresh command and the second command comprises an activate command, and wherein entering power-down after receiving the activate command is caused in response to the activate command.

39. The method of claim 37 wherein the first command comprises a refresh command and the second command comprises an no operation command, and wherein entering power-down after receiving the no operation command is caused in response to the refresh command.

40. The method of claim 37 wherein the first command comprises a refresh command and the second command comprises an no operation command, and wherein entering power-down after receiving the no operation command is caused in response to a number of consecutive deselect commands.
